(19) United States
(12) Patent Application Publication
(10) Pub. No.: US 2006/0068654 A1
(43) Pub. Date: Mar. 30, 2006

(54) Programmable electrical connector comprising an electromechanical programmer

(76) Inventor: Romain Guillot, Mionnay (FR)

Correspondence Address: Ralph A. Dowell of DOWELL & DOWELL P.C., 2111 Eisenhower Ave, Suite 406, Alexandria, VA, 22314, US

(21) Appl. No.: 11/237,890

(22) Filed: Sep. 29, 2005

(30) Foreign Application Priority Data
Sep. 29, 2004 (FR) 04 10304

(51) Int. Cl. H01R 13/73

(52) U.S. Cl. 439/894

(57) ABSTRACT

This connector comprises an electrical inlet plug and outlet socket and a current control programmer. This programmer comprises, on the one hand, electromechanical programming means capable of automatically controlling the passage and interruption of current in accordance with an adjustable time cycle and, on the other hand, means for selecting an operating mode of the programmer from among three possible modes, one of which modes (“AUTO mode”) corresponds to automatic operation of the programmer imposed by the programming means, while the other modes (“ON mode” and “OFF mode”) correspond to control of the passage and interruption of current independently of the programming means. In order to assist the user in understanding which operating mode of the programmer is in effect, the connector furthermore comprises luminous display means controlled by said selection means and capable of providing a luminous display specific to each operating mode of the programmer.

The present invention relates to a programmable electrical connector. It applies in particular to the field of home automation and, more generally, to the automated management of an electrical appliance with the aim of supplying said appliance in accordance with an adjustable time cycle.

Existing programmable connectors, which are intended to be interposed electrically between a current source and an appliance, are only capable of permitting the source to supply this appliance for one or more time periods, said supply being cyclic, generally with a period of one day. To this end, these programmable connectors are frequently provided with electromechanical programmers, which are less costly than electronic programming devices. This type of programmer comprises a programming dial, generally in the form of a rotary wheel bearing divisions which represent the twenty four hours of a day, and which is equipped with segments allowing the user to define the time interval(s) during which it is desired for the connected electrical appliance to be supplied.

In addition to the programming dial, it is known, for example from DE-A-24 05 044, to equip such programmers with a button which may be actuated by user from the outside of the casing of the connector, with the aim of setting the programmer into different possible operating modes. Such a button may thus be displaced between a first position corresponding to an automatic operating mode in which the passage of current through the connector depends on the intervals defined on the programming dial, a second, override position imposing passage of current through the connector, independently of the position of the programming dial, and a third, override position shutting off the electrical supply to the appliance connected to the connector, independently of the position of the programming dial. Using such a selector button enables the user to suspend automatic operation of the programmer without changing the settings of the programming dial.

However, the presence of this button requires particular vigilance on the part of the user with regard to its position since, in the event of a memory lapse or incorrect positioning of the button, there is a risk that the expected supply or isolation of the appliance connected to the connector will not occur. In practice, this drawback is a particular nuisance to the user because the button is generally arranged on part of the connector casing which is relatively difficult to reach and/or to see. This issue is so huge than the user is often led to give up these “multi-mode” programmers, which are however actually interesting, for programmers with only one possible operating mode.

The object of the present invention is to provide a programmable electrical connector which, while allowing the user to select several different operating modes, is easier to use and more reliable in operation.

To this end, the invention provides a programmable electrical connector, which comprises an electrical inlet plug, at least one electrical outlet socket and a programmer capable of controlling the passage and interruption of current between the inlet plug and the or at least some of the outlet sockets, which programmer comprises, on the one hand, electromechanical programming means capable of automatically controlling the passage and interruption of current in accordance with an adjustable time cycle, and, on the other hand, means for selecting an operating mode of the programmer from among at least two possible modes, one of which modes corresponds to automatic operation of the programmer imposed by the programming means, while the other mode or modes correspond(s) to control of the passage and/or interruption of current independently of the programming means, characterised in that it furthermore comprises luminous display means controlled by the selection means and capable of providing a luminous display specific to each operating mode of the programmer.

The luminous display means of the connector according to the invention allow the user to ascertain the operating mode of the programmer at a glance during selection and thus to check that the desired mode has indeed been selected. Should this not be the case, the user actuates the selection means until the selected operating mode corresponds to the desired mode. Even if the part of these selection means actuated by the user is difficult to reach or see and the user is proceeding by trial and error, the luminous display provided by the connector enables the user easily and rapidly to determine which operating mode has just been selected.

Depending on other features of this connector, taken in isolation or according to all technically possible combinations:
the display means comprise an indicator light capable of lighting either when the selected operating mode is the mode corresponding to control of the passage of current independently of the programming means, or when, on the one hand, the selected operating mode is the automatic operating mode and, on the other hand, the programming means are enabling the passage of current;
the programming means comprise a display dial for time divisions and the display means comprise dial illumination means capable of illuminating the dial, in particular by backlighting, when the selected operating mode is the automatic operating mode;
the programming means comprise a time reference pointer, which is stationary relative to the dial, and the display means comprise pointer illumination means, capable of illuminating the pointer at the same time as the dial and/or the indicator light;
it comprises a casing within which the programmer is in part arranged and the display means comprise an electrical control circuit, disposed within the casing and comprising, on the one hand, a first contactor electrically connected to one of the socket/plug, which is mobile relative to the casing and caused to move by the programming means, and, on the other hand, a second contactor connected electrically to the other socket/plug, which is displaceable relative to the casing between positions which are respectively associated with the different possible operating modes and caused to move by the selection means of the programmer;
with this connector:
   when the second contactor is in the position associated with the automatic operating mode, the first contactor is displaceable between a position in which it is in contact with the second contactor and a position in which it is located at a distance from the second contactor, and
   when the second contactor is in the position associated with the mode corresponding to control of the passage of current independently of the programming means, the first contactor is immobilised in contact with the second contactor, however it is actuated by the programming means, and/or
   when the second contactor is in the position associated with the mode corresponding to control of interruption of current independently of the programming means, the first contactor is kept at a distance from the second contactor, however it is actuated by the programming means, and/or;
the indicator light is borne on a branch line electrically connecting the first contactor to an earth of the circuit;
the dial illumination means are borne by a branch line equipped, at one of its ends, with a third contactor and connected, at its opposite end, to an earth of the circuit, and the third contactor is disposed stationarily relative to the casing, such that the second and third contactors are in contact with one another when the second contactor is in the position associated with the automatic operating mode, while the second and third contactors are at a distance from one another when the second contactor is in the or each position associated with the mode(s) corresponding to control of the passage and/or interruption of current independently of the programming means;
the casing is equipped with internal stops which are immobilised relative to the casing and arranged to limit the amplitude of the movements of the first contactor relative to the casing;
at least one of the stops is borne by a part capable of being placed within the casing according to several different configurations, which correspond respectively to different degrees of amplitude limitation.

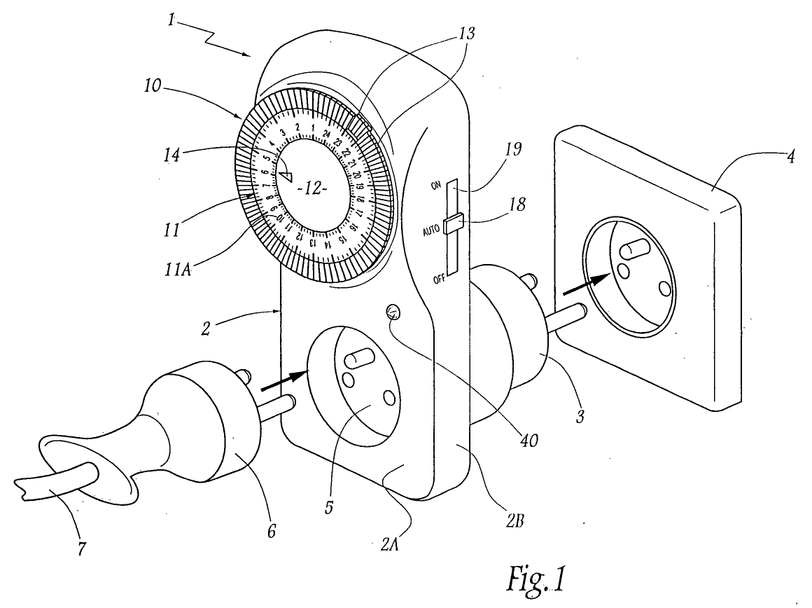

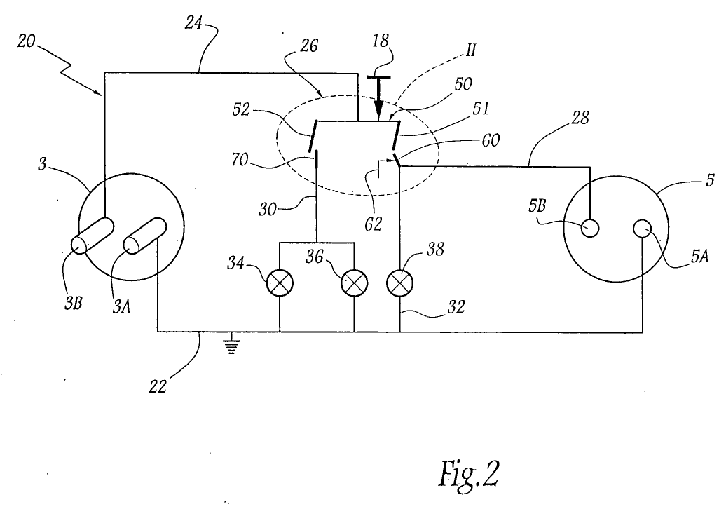

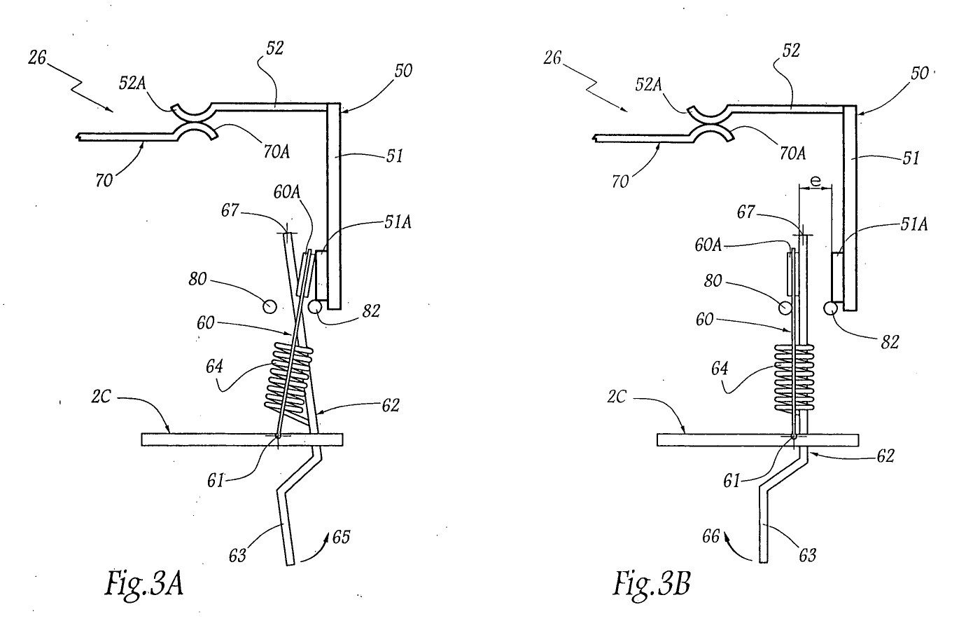

The invention will be better understood on reading the following description, which is provided purely by way of example and given with reference to the drawings, in which:
FIG. 1 is a perspective view of an electrical connector according to the invention;
FIG. 2 is a circuit diagram of a part of the connector of FIG. 1; and
FIGS. 3A, 3B, 4A, 4B, 5A and 5B are schematic elevational views of an example of embodiment of the part circled II in FIG. 2, illustrating respectively different operating states of this part of the electrical circuit of the connector.

FIG. 1 shows a programmable electrical connector 1 comprising an electromechanical programmer 10, which is partially visible in FIG. 1, the remainder of this programmer being accommodated in an external casing 2 of the connector. The connector 1 furthermore comprises, on the one hand, a plug 3 capable of being introduced into a socket 4, such as a wall socket, and, on the other hand, a socket 5 capable of receiving a plug 6 constituting the end of an electrical supply lead 7 of an appliance. The programmer 10 controls the passage of current from the wall socket 4 towards the lead 7 as a function of adjustments made by the user.

To this end, the part of the programmer 10 accessible to the user, i.e. the part of the programmer located on the outside of the casing 2 at the level of a face 2A of this casing, comprises a programming dial 11 in the form a wheel mounted rotatably around a stationary hub 12 integral with the casing 2. In the Example shown, the dial 11 bears, on its face 11A which is overall parallel to the face 2A of the casing, two series of divisions distributed uniformly respectively around the internal and external peripheries of the dial. Each series comprises twenty four main divisions, respectively associated with an increasing number rising regularly from 1 to 24, together with secondary divisions, of which there are three between two successive main divisions. When in operation, the dial 11 is intended to perform a complete revolution around the hub 12 in twenty four hours and at a constant speed, such that it will be understood that each main division corresponds to one hour of the day, while the three secondary divisions between two successive main divisions correspond to the quarter hours separating two successive hours.

The programming dial 11 is equipped around its external periphery with ninety six segments 13, each segment being associated with an angular sector separating either two successive secondary divisions, or a successive main division and a secondary division. Each element 13 is fitted movably on the dial 11, between a pushed in position, as shown in the upper part of FIG. 1 for certain of the segments, and a pulled out position, as shown for the other segments. As is explained below, depending on whether the segment 13 is in the pushed in or pulled out position, passage of current through the connector 1 is respectively enabled or prevented.

In this manner, the user may select one or more time intervals, of a minimum duration of a quarter of an hour, during which the lead 7 is supplied by the wall socket 4. In the Example shown, the lead is supplied for one hour, between 22:00 and 23:00.

In order to locate the angular position of the dial 11 in time as it rotates around the hub 12, the programmer 10 is equipped with a time reference pointer 14, in the form an arrow borne by the hub. In practice, the user manually synchronises the dial 11 with the current time such that the reading of the time division of the dial indicated by the pointer 14 actually corresponds to the time of day in question as the dial 11 rotates.

On a side 2B of the casing 2, which side is perpendicular to the face 2A, the programmer 10 is furthermore equipped with a button 18 for selecting the operating mode of the programmer from among three possible modes. The button 18 may be displaced translationally along a slider 19 defined by the side 2B of the casing between three positions corresponding to the two longitudinal ends and to the central part of the guide groove 19. Each position, labelled along the groove by “ON”, “AUTO” and “OFF”, is thus associated with one of the three operating modes of the programmer. This button 18 is also known as an “override button”since it enables the programmer 10 to depart from “AUTO” operating mode in favour of one of other two possible modes.

The connector 1 is configured to provide luminous displays specific to each operating mode of the programmer 10. To this end, the programmer is equipped with an electrical circuit 20, shown diagrammatically in FIG. 2. This circuit comprises an earth line 22 directly connecting a terminal 3A of the plug 3 to a terminal 5A of the socket 5. The other terminal 3B of the plug 3 is connected to a potential line 24 connected to the other terminal 5B of the socket 5 successively via a switch assembly 26, described in detail below, and a direct line 28. Taking account of the earth and potential lines facilitates presentation of the circuit 20. However, in practice, the lines respectively connecting terminals 3A and 5A, and 3B and 5B are generally exposed to alternating current.

The circuit 20 furthermore comprises two branch lines 30 and 32, connected respectively to the potential line 24, via the switch assembly 26, and directly to the line 28. The line 30 is provided, in parallel, with a block of light-emitting diodes 34 and a light-emitting diode 36, while line 32 is provided with a light-emitting diode 38.

The block of diodes 34 is arranged within the casing 2, at the level of the dial 11, so as to provide backlighting for the time divisions of the ?dial. In other words, when the block of diodes 34 is supplied, the time divisions of the dial emit light directed towards the outside of the casing, i.e. visible by the user observing the face 2A of the connector 1.

The diode 36 is arranged within the casing 2, at the level of the pointer 14, so as to illuminate this pointer for the user. The diode 36 is for example an LED, the light output from which is guided by a light guide to the pointer 14 which constitutes the output face of said light guide. In practice, this light guide is a plastics part, the faces of which are shaped so as to internally reflect the light emitted by the LED to a light emitting face constituting the pointer.

The diode 38 is associated with an additional indicator light 40 (FIG. 1) disposed at the level of the face 2A of the casing 2. In practice, this indicator is constituted by the output face of a light guide arranged within the casing and capable of guiding the light emitted by the diode 38.

Advantageously, the light emitted by the block of diodes 34 and the diodes 36 and 38 may respectively have different colours, which facilitates their identification by the user. By way of example, the pointer 14 is illuminated by red-coloured light, while the dial 10 and the power supply indicator 40 are illuminated by blue-coloured light.

FIG. 3A is a schematic representation of the switch assembly 26. This assembly comprises a first cranked metallic blade 50, having two arms 51 and 52 each having at their free end an electrical contact zone 51A and 52A. The blade 50 is kinematically connected to the button 18 such that displacement of this button along the groove 19 brings about translation of the blade 50 relative to the casing 2.

As shown only in FIG. 2, the blade 50 is electrically connected to the potential line 24.

The switch assembly 26 comprises a second metallic blade 60 having, at one of its ends, an electrical contact zone 60A. At its opposite end, the blade 60 is rocker mounted on an internal rib 2C of the casing 2, about an axis 61. Rocker operation of this blade 60 is provided by a mechanical actuator 62 which is rocker mounted relative to the casing 2, about an axis 67 parallel to the axis 61. One part of the end 63 of this actuator 62 is intended to cooperate, via a lever which is not shown, with the segments 13 of the programming dial 11. This lever is actually arranged in the circular trajectory of the segments 13, driven by the rotary dial 11, when these segments are in the pushed in position while, when the segments are in the pulled out position, there is no mechanical interaction with this lever. Transmission of the movement of the actuator 62 to the blade 60 is performed by a spring 64, the ends of which are respectively integral with the actuator and the blade. The mechanical rocker structure comprising the blade 60, the actuator 62 and the spring 64 occupy little space in the casing 2.

As shown only in FIG. 2, the blade 60 is electrically connected to the line 28 of the circuit 20.

The switch assembly 26 also comprises a third metallic blade 70 arranged stationarily inside the casing 2. This blade has an extreme contact zone 70A intended, when in operation, to interact with the contact zone 52A of the blade 50.

As indicated only in FIG. 2, the blade 70 is the end part of the branch line 30.

Operation of the connector 1, in accordance with each of the operating modes of its programmer 10, is as follows:

1) Automatic Operating Mode, Known as “AUTO Mode” (FIGS. 3A and 3B):

The button 18 is in “AUTO” position, as in FIG. 1. The blade 50 is then in the position shown in FIGS. 3A and 3B. When, over the course of the rotary motion of the dial 11 around the hub 12, the actuator 62 is rocked, via the above-mentioned lever which is not shown, about the axis 67 by one of the pushed in segments 13, as indicated by the arrow 65 in FIG. 3A, the actuator, via the spring 64, rocks the blade 60 about its axis 61 until its contact zone 60A comes to rest against the contact zone 51A of the blade 50. In this configuration, the blades 50 and 60 electrically connect the potential line 24 to the line 28, so permitting the passage of current between the plug 3 and the socket 5. Current furthermore passes through the branch line 32, causing the diode 38 to light and so illuminating the indicator 40. The configuration of FIG. 3A then applies.

Then, when the actuator 62 is located in association with a pulled out segment, it is returned to its original position, as indicated by the arrow 66 in FIG. 3B, bringing about an opposite rocking movement of the blade 60 by the intermediary of the spring 64. Electrical contact between the zones 60A and 51A is then broken, so disconnecting both of lines 24 and 28 of the circuit 20. The passage of current through the connector 1 is suspended and the indicator 40 is extinguished. The configuration of FIG. 3B then applies.

Furthermore, in its position of FIGS. 3A and 3B, the blade 50 is in contact, at the level of its zone 52A, with the zone 70A of the blade 70. An electrical current is therefore passing through the branch line 30, supplying the block of diodes 34 and the diode 36. The dial 11 is thus backlit and the pointer 14 is illuminated, and this is independently of the position of the blade 60, i.e. independently of the passage or interruption of current through the connector 1 controlled by the segments 13.

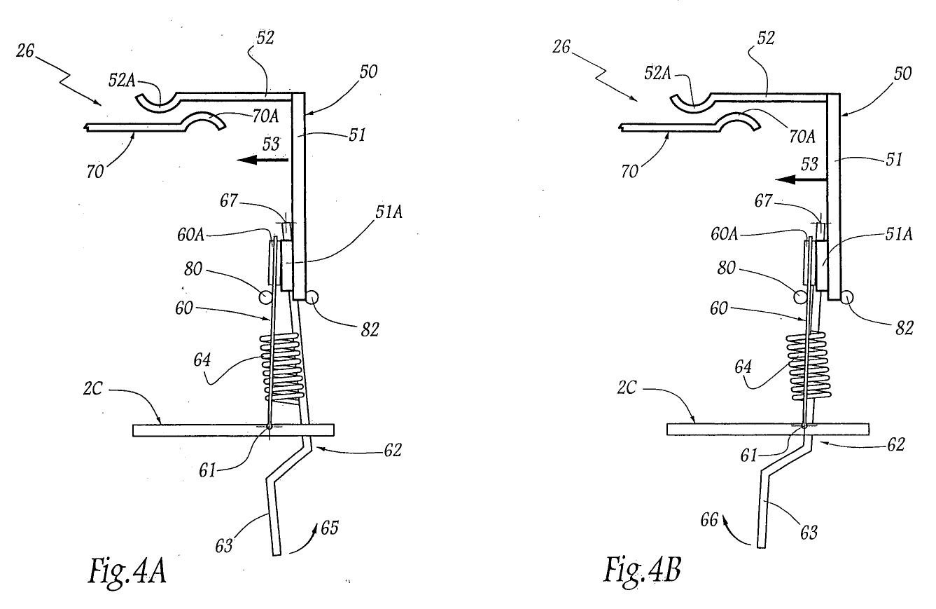

2) Continuous Operation Operating Mode, Known as “ON Mode” (FIGS. 4A and 4B):

From its intermediate position in FIG. 1, the button 18 is pushed by the user to the “ON” position, causing translation of the blade 50 to its position in FIGS. 4A and 4B, as indicated by a arrow 53. During the translation of this blade, its electrical contact zone 51A is displaced in the direction of the contact zone 60A of the blade 60, over a distance at least substantially equal to the gap e between zones 51A and 60A in FIG. 3B. In this manner, as shown in FIGS. 4A and 4B, these zones 51A and 60A are in permanent contact with one another, whatever the configuration of the actuator 62 relative to the blade 60. In other words, the potential line 24 of the circuit 20 is connected continuously to the line 28, independently of the pushed in or pulled out configuration of the segments 13 of the programming dial 11. Electrical current can thus pass freely between the plug 3 and socket 5 of the connector 1, without taking account of the angular position of the dial 11. Furthermore, as for the automatic operating mode, the diode 38 is then supplied and the indicator 40 is thus illuminated.

In order to ensure reliable and permanent contact between the zones 51A and 60A, the casing 2 is equipped with a stationary stop 80 disposed on the opposite side of the blade 60 from the arm 51 of the blade 50. This stop 80 is positioned so as, in cooperation with the arm 51, to immobilise at least the zone 60A of the blade 60 when this blade is loaded by the actuator 62.

Furthermore, when the blade 50 is in its translated position of FIGS. 4A and 4B, its contact zone 52A is at a distance from the contact zone 70A of the stationary blade 70. In this manner, the branch line 30 is open and the diodes 34 and 36 are no longer supplied. The dial 11 and the pointer 14 are therefore extinguished.

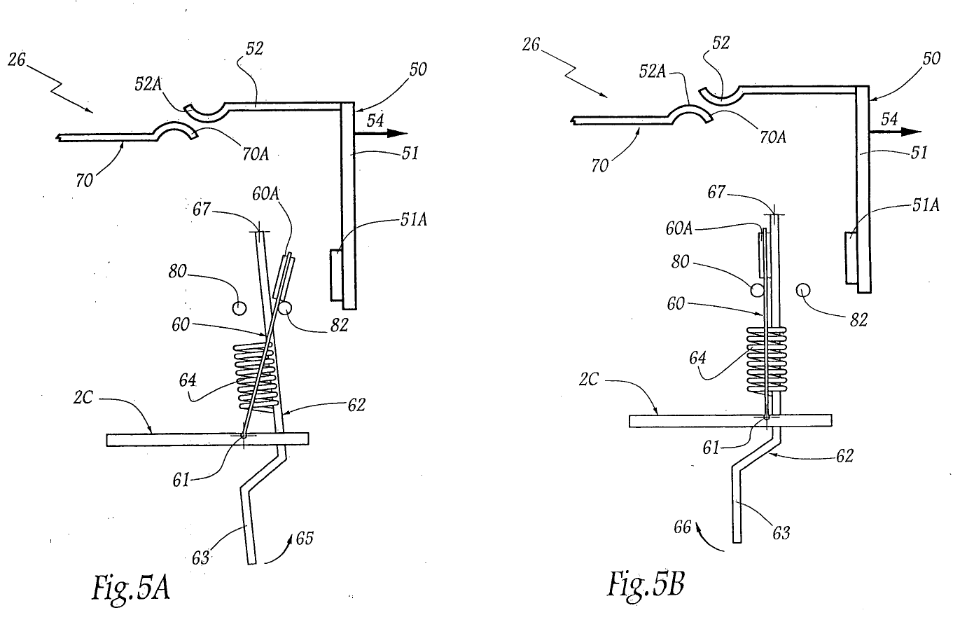

3) Continuous Interruption Operating Mode, Known as “OFF Mode” (FIGS. 5A and 5B):

From its “ON” or “AUTO” position, the button 18 is adjusted by the user into its “OFF” position, which translationally displaces the blade 50 in accordance with an arrow 54 shown in FIGS. 5A and 5B. In this position, the electrical contact zone 51A of the arm 51 is sufficiently distant from the contact zone 60A of the blade 60 to avoid any contact between these zones however it is rocked by the actuator 62. In order to restrict the rocking amplitude of the blade 60 about its axis 61 in the direction of the arm 51, the casing 2 is equipped with an additional stop 82, similar to the stop 80 and located between the respective positions of the contact zone 51A for “AUTO mode” and “OFF mode”. In other words, the stop 82 is positioned so as not to obstruct rocking of the blade 60 when the connector is in “AUTO mode” (FIGS. 3A and 3B) while this stop limits the rocking stroke of the blade 60 in the direction of arm 61 when in “OFF mode”.

Since the electrical contact zones 51A and 60A are constantly apart, lines 24 and 28 of the circuit 20 are not connected to one another and electrical current through the connector 1 is interrupted. The indicator 40 is extinguished.

Furthermore, in its translated position of FIGS. 5A and 5B, the contact zone 52A of the blade 50 is at a distance from the contact zone 70A of the stationary blade 70, such that, as in “ON mode”, the branch line 30 is open. The dial 11 and the pointer 14 are extinguished.

Thus, by looking at the face 2A of the casing 2, the user receives a reliable indication from the lights which allows him/her rapidly and easily to determine which operating mode the programmer 10 is in:
if the dial 11 and the pointer 14 are illuminated, the user will infer that the programmer 10 is in “AUTO mode” and if, in addition, the indicator 40 is illuminated, the user will conclude that the dial 11 is at present enabling the passage of current through the connector 1, while, if this indicator 40 is extinguished, he/she will conclude that a programming interval which effects interruption of current through the connector is under way; this implies that, in that case, the luminous display elements controlled by the button 18 and by the segments 13 follow a combinatory logic; and
if the dial 11 and the pointer 14 are extinguished, the user will conclude that either the programmer 10 is in “ON mode” if the indicator 40 is illuminated, or that this programmer is in “OFF mode” if the indicator is extinguished.

In a variant which is not shown, just one further mode other than “AUTO mode” is present, for example either the “ON mode” or the “OFF mode” described above. Other preset modes, i.e. which cannot be programmed by the user by means of the dial 11, may be provided instead of or in addition to the “ON” and “OFF” modes.

Likewise in a variant which is not shown, rather than providing for the pointer 14 to be illuminated concomitantly with the dial 11, illumination of this pointer may be provided concomitantly with that of the power supply indicator 40. The diode 36 is then arranged at the level of the branch line 32.

Various modifications and variants of the above-described connector 1 and programmer 10 are furthermore conceivable. In particular, the shape and the dimensions of the contact blades 50, 60 and 70 are merely illustrative and may be adjusted to the internal geometry of the casing 2 of the connector. Likewise, displacement of the blade 50 in a translational movement is merely illustrative and other movement kinematics may be imparted by sliding the button 18.

Furthermore, conversely to the above-described example, passage of current through the connector 1 may, on the one hand, be prevented when the segment 13 indicated by the pointer 14 is in pushed in position and, on-the other hand, enabled when this segment is in pulled out position.

Likewise, although the example shown relates to a dial with ninety six segments, this subdivision of time does not restrict the invention and the number of segments used may be larger or smaller, for example equal to one hundred and forty four or to forty eight.

As an optional variation, the stop 80 and/or the stop 82 are not permanently integral with the casing 2 but are on the contrary borne by at least one part which may be placed within said casing in various predetermined configurations. In a first configuration, this part positions the stops 80 and 82 within the casing 2 as shown in FIGS. 3 to 5 while, in a second configuration, the distance between these stops 80 and 82 is made larger, the position relative to the stop 80 being for example offset leftwards in the above-stated Figures. In this manner, the rocking amplitude of the blade 60 varies depending on the particular configuration of the stated inserted part. The programmer 10 may thus be configured as a programmer with an astable blade 60, as described above with regard to FIGS. 3 to 5, or as a programmer with a bistable blade 50, i.e. in which the blade 60 passes from one rocker position to the other under the sole action of the segments 13, without the intervention of a resilient return element, such as that enabling the return movement indicated by the arrow 66 in FIGS. 3B, 4B and 5B. Such a programmer with a bistable blade 60 is used, for example, in a programmable timer or in a programmable connector/switch commonly known as a “single-program programmer”.

Furthermore, the arrangement and the nature of the plug 3 and socket 5 of the connector 1 are merely illustrative and the invention applies to connectors whose plug/socket may, for example, be located substantially coaxially with the programming dial 11 and/or on one or more faces of the casing 2 other than the face of the dial 11. Furthermore, the invention also applies to connectors having several outlet sockets, only some or all of which sockets being controlled, from the standpoint of passage of current through the connector, by the programmer 10.

Furthermore, the invention is not restricted to connectors equipped with plugs for insertion into complementary sockets as in FIG. 1, but also relates to connectors for incorporation into an electrical panel for controlling a stationary appliance, such as a swimming pool filter motor or an outdoor lighting system, the terminals of the connector then being connected by soldered joints, connector blocks or the like.

1. A programmable electrical connector, which comprises:
an electrical inlet plug,
at least one electrical outlet socket,
a programmer capable of controlling the passage and interruption of current between the inlet plug and the or at least some of the outlet sockets, which programmer comprises, on the one hand, electromechanical programming means capable of automatically controlling the passage and interruption of current in accordance with an adjustable time cycle, and, on the other hand, means for selecting an operating mode of the programmer from among at least two possible modes, one of which modes (“AUTO mode”) corresponds to automatic operation of the programmer imposed by the programming means, while the other mode or modes (“ON mode” and/or “OFF mode”) correspond(s) to control of the passage and/or interruption of current independently of the programming means, and
luminous display means controlled by said selection means and capable of providing a luminous display specific to each operating mode of the programmer.

2. A connector according to claim 1, wherein the display means comprise an indicator light capable of lighting either when the selected operating mode is the mode (“ON mode”) corresponding to control of the passage of current independently of the programming means, or when, on the one hand, the selected operating mode is the automatic operating mode (“AUTO mode”) and, on the other hand, the programming means are enabling the passage of current.

3. A connector according to claim 1, wherein the programming means comprise a display dial for time divisions and wherein the display means comprise dial illumination means capable of illuminating the dial, in particular by backlighting, when the selected operating mode is the automatic operating mode (“AUTO mode”).

4. A connector according to claim 2, wherein the programming means comprise a display dial for time divisions, wherein the display means comprise dial illumination means capable of illuminating the dial, in particular by backlighting, when the selected operating mode is the automatic operating mode (“AUTO mode”), wherein the programming means comprise a time reference pointer, which is stationary relative to the dial, and wherein the display means comprise pointer illumination means, capable of illuminating the pointer at the same time as the dial and/or the indicator light.

5. A connector according to claim 1, wherein it comprises a casing within which the programmer is in part arranged and wherein the display means comprise an electrical control circuit, disposed within the casing and comprising, on the one hand, a first contactor electrically connected to one of the socket/plug, which is mobile relative to the casing and caused to move by the programming means, and, on the other hand, a second contactor connected electrically to the other socket/plug, which is displaceable relative to the casing between positions which are respectively associated with the different possible operating modes and caused to move by the selection means of the programmer.

6. A connector according to claim 5, characterised in that:
when the second contactor is in the position associated with the automatic operating mode (“AUTO mode”), the first contactor is displaceable between a position in which it is in contact with the second contactor and a position in which it is located at a distance from the second contactor, and
when the second contactor is in the position associated with the mode (“ON mode”) corresponding to control of the passage of current independently of the programming means, the first contactor is immobilised in contact with the second contactor, however it is actuated by the programming means, and/or
when the second contactor is in the position associated with the mode (“OFF mode”) corresponding to control of interruption of current independently of the programming means, the first contactor is kept at a distance from the second contactor, however it is actuated by the programming means.

7. A connector according to claim 2, wherein it comprises a casing within which the programmer is in part arranged, wherein the display means comprise an electrical control circuit, disposed within the casing and comprising, on the one hand, a first contactor electrically connected to one of the socket/plug, which is mobile relative to the casing and caused to move by-the programming means, and, on the other hand, a second contactor connected electrically to the other socket/plug, which is displaceable relative to the casing between positions which are respectively associated with the different possible operating modes and caused to move by the selection means of the programmer, and wherein the indicator light is borne by a branch line electrically connecting the first contactor to an earth of the circuit.

8. A connector according claim 3, wherein it comprises a casing within which the programmer is in part arranged, wherein the display means comprise an electrical control circuit, disposed within the casing and comprising, on the one hand, a first contactor electrically connected to one of the socket/plug, which is mobile relative to the casing and caused to move by the programming means, and, on the other hand, a second contactor connected electrically to the other socket/plug, which is displaceable relative to the casing between positions which are respectively associated with the different possible operating modes and caused to move by the selection means of the programmer, and wherein the dial illumination means are borne by a branch line equipped, at one of its ends, with a third contactor and connected, at its opposite end, to an earth of the circuit, and in that the third contactor is disposed stationarily relative to the casing, such that the second and third contactors are in contact with one another when the second contactor is in the position associated with the automatic operating mode (“AUTO mode”), while the second and third contactors are at a distance from one another when the second contactor is in the or each position associated with the mode(s) (“ON mode” and/or “OFF mode”) corresponding to control of the passage and/or interruption of current independently of the programming means.

9. A connector according to claim 5, wherein the casing is equipped with internal stops which are immobilised relative to the casing and arranged to limit the amplitude of the movements of the first contactor relative to the casing.

10. A connector according to claim 9, characterised in that at least one of the stops is borne by a part capable of being placed within the casing according to several different configurations, which correspond respectively to different degrees of amplitude limitation.
